(19) United States
(12) Patent Application Publication
(10) Pub. No.: US 2012/0286971 A1
(43) Pub. Date: Nov. 15, 2012

(54) SIGNAL SYSTEM

(75) Inventor: Kazuma SEKIYA, Ota-Ku (JP)

(73) Assignee: DISCO CORPORATION, Tokyo (JP)

(21) Appl. No.: 13/450,742

(22) Filed: Apr. 19, 2012

(30) Foreign Application Priority Data
May 11, 2011 (JP) 2011-106020

(51) Int. Cl. G08G 1/095

(52) U.S. Cl. 340/907

(57) ABSTRACT

A signal system for operating a traffic signal includes a signal light, a control unit for controlling the operation of the signal light, and a power selecting mechanism for selecting the power to be supplied to the control unit between a commercial power supply and a battery mounted in a vehicle. The power selecting mechanism includes a battery route having a pair of connection terminals adapted to be connected to the battery of the vehicle, and an electromagnetic switch normally connecting the commercial power supply to the control unit. When the supply of commercial power is cut, the electromagnetic switch automatically performs switching so that the commercial power is disconnected from the control unit and the battery route is connected to the control unit. Further, the battery of the vehicle is connected to the connection terminals in the event of a power failure, thereby operating the traffic signal.

### BACKGROUND OF THE INVENTION

1. Field of the Invention

The present invention relates to a signal system capable of temporarily operating a traffic signal in the event of a power failure due to a natural disaster such as an earthquake.

2. Description of the Related Art

A traffic signal located at an intersection of streets or the like is connected to a commercial power supply to which power is supplied from an electric power company, thereby controlling the traffic of vehicles in time sequence to allow smooth passing of the vehicles. The signal light of the traffic signal is composed of a blue (green), yellow, and red signal lights, which are common in the world. In general, light bulbs are conventionally used as these signal lights. However, since a light bulb consumes large power and requires periodic replacement, there is a recent trend that it is shifted to a light emitting diode (LED) which can suppress a power consumption to about 15 W and can extend the life to about seven to ten years. However, in the event that a power failure occurs due to a disaster such as an earthquake or a fire, the traffic signal fails to operate, causing traffic trouble such as traffic accidents and traffic congestion until the power is restored or traffic is directed by a police officer. To cope with this problem, there has been proposed a technique for preparation for a power failure such that the traffic signal is always equipped with a battery for temporarily operating the traffic signal even in the event that the connection between the commercial power supply and the traffic signal is cut due to a power failure (Japanese Utility Model Registration No. 3058107). Further, a generator is provided at a main intersection of national roads or main prefectural roads in preparation for a possible power failure.

### SUMMARY OF THE INVENTION

However, in the case that the traffic signal is always equipped with a battery as described in Japanese Utility Model Registration No. 3058107, periodic maintenance is required for the battery, causing an enormous maintenance cost. Further, in providing a generator at a main intersection, a great amount of cost is required. In addition, traffic congestion may occur at any other intersections where no generators are provided in the event of a power failure.

It is therefore an object of the present invention to provide a signal system which can continue the operation of a traffic signal without stopping even in the event of a power failure and can eliminate the need for periodic maintenance.

In accordance with an aspect of the present invention, there is provided a signal system for operating a traffic signal, including: a signal light; a control unit for controlling the operation of the signal light; a commercial power supply connected to the control unit; and a battery route adapted to be connected to the control unit, the battery route having connection terminals, wherein when the supply of power from the commercial power supply is cut, a battery mounted on a vehicle is connected to the connection terminals of the battery route to thereby operate the traffic signal.

In accordance with another aspect of the present invention, there is provided a signal system for operating a traffic signal, including: a signal light; a control unit for controlling the operation of the signal light; and a power selecting mechanism for selecting the power to be supplied to the control unit between a commercial power supply and a battery mounted on a vehicle, wherein the power selecting mechanism includes a battery route having a pair of connection terminals adapted to be connected to the battery of the vehicle, and an electromagnetic switch normally connecting the commercial power supply to the control unit, when the supply of power from the commercial power supply is cut, the electromagnetic switch automatically performs switching so that the commercial power supply is disconnected from the control unit and the battery route is connected to the control unit, and the battery of the vehicle is connected to the connection terminals in the event of a power failure, thereby operating the traffic signal.

According to the signal system of the present invention, the traffic signal can be operated by the battery mounted in a vehicle such as a patrol car, police motorcycle, and general car. Accordingly, even in the event of a power failure, the operation of the traffic signal can be continued without stopping, thereby preventing traffic trouble such as traffic accidents and traffic congestion. Further, no periodic maintenance is required, so that an enormous maintenance cost can be suppressed.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a schematic illustration showing a general configuration of a signal system according to the present invention; and

FIG. 2 is a schematic diagram showing the configuration of the signal system including a power selecting mechanism therein, according to a preferred embodiment of the present invention.

### DETAILED DESCRIPTION OF THE PREFERRED EMBODIMENTS

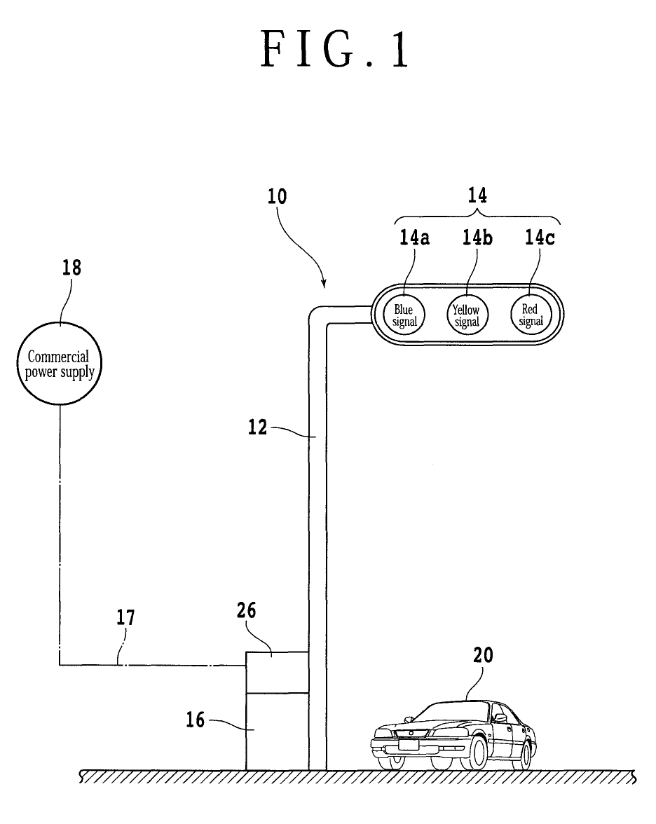

A preferred embodiment of the present invention will now be described in detail with reference to the drawings. Referring to FIG. 1, there is shown a general configuration of a signal system according to a preferred embodiment of the present invention. Reference numeral 10 generally designates a traffic signal including a post 12 provided at an intersection of streets and a signal light 14 mounted at the front end of the post 12. The signal light 14 is composed of a blue signal (green signal) 14a, a yellow signal 14b, and a red signal 14c. In this preferred embodiment, the signal light 14 is of a horizontal type such that the blue signal 14a, the yellow signal 14b, and the red signal 14c are horizontally arranged in a line. The blue signal 14a, the yellow signal 14b, and the red signal 14c are arranged in this order from the curb of a street.

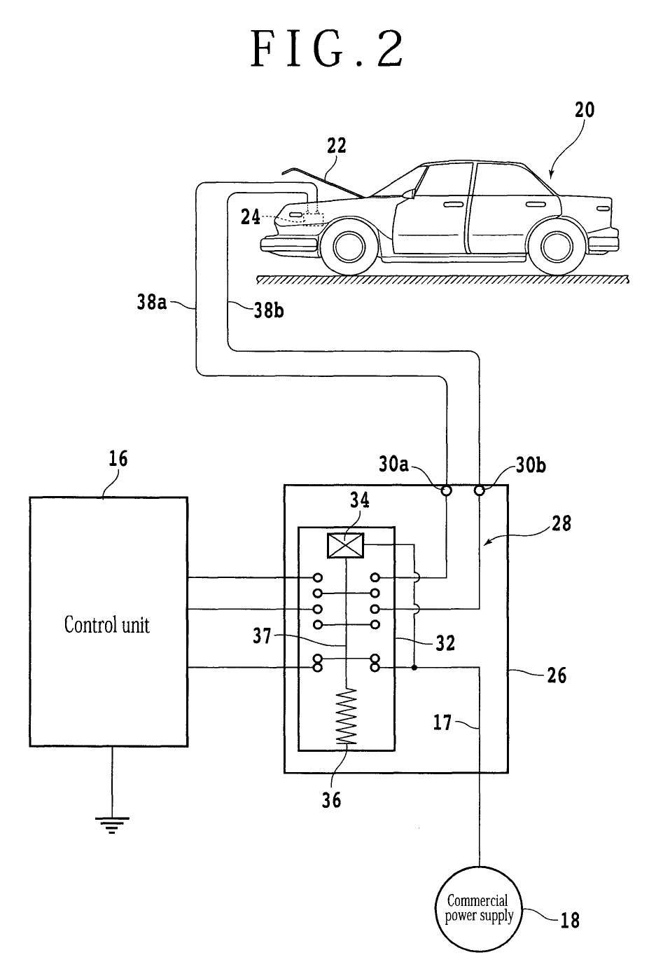

The operation of the signal light 14 of the traffic signal 10 is controlled by a control unit 16. A power selecting mechanism 26 is mounted on the control unit 16. As shown in FIG. 2, the power selecting mechanism 26 includes a battery route 28 and an electromagnetic switch 32. The battery route 28 has a pair of connection terminals 30a and 30b adapted to be connected to a battery 24 mounted in a vehicle 20. The electromagnetic switch 32 functions to selectively connect the battery route 28 and an electric wire 17 that is connected to a commercial power supply 18, to the control unit 16. The electromagnetic switch 32 has an electromagnetic coil 34 and a coil spring 36. In the normal operation of the traffic signal 10, the electromagnetic coil 34 is energized by the power supplied from the commercial power supply 18 to thereby connect the commercial power supply 18 to the control unit 16, thus maintaining the operation of the traffic signal 10.

When a large-scale power failure occurs due to a natural disaster such as an earthquake, the electromagnetic coil 34 of the electromagnetic switch 32 is turned off (de-energized), so that a switch member 37 is moved upward by the biasing force of the coil spring 36. As a result, the connection of the commercial power supply 18 and the control unit 16 is cut, whereas the battery route 28 is connected to the control unit 16. This selection of power is performed simultaneously with the occurrence of a power failure. Accordingly, in the event that such a large-scale power failure occurs, a police station can detect this power failure or recognize the occurrence of the power failure through the information from a third party, and the police station hastens the vehicle 20 such as a patrol car to an intersection where the power failure has occurred. At this intersection, an engine hood (bonnet) 22 of the vehicle 20 is opened to connect the battery 24 in the vehicle through connection cables (jumper wires) 38a and 38b to the connection terminals 30a and 30b of the battery route 28.

Accordingly, the battery 24 mounted in the vehicle 20 is connected through the electromagnetic switch 32 to the control unit 16, so that the traffic signal 10 that has failed to operate due to the power failure can be powered again, thereby preventing the occurrence of traffic trouble such as traffic congestion and traffic accidents. The capacity of the battery 24 mounted in the vehicle 20 is limited. However, in the case that the battery 24 mounted in the vehicle 20 is fully discharged to power off the traffic signal 10 again, a battery mounted in another vehicle such as an automobile may be connected to the connection terminals 30a and 30b to thereby continue the operation of the traffic signal 10.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A signal system for operating a traffic signal, comprising:
a signal light;
a control unit for controlling the operation of said signal light;
a commercial power supply connected to said control unit; and
a battery route adapted to be connected to said control unit, said battery route having connection terminals,
wherein when the supply of power from said commercial power supply is cut, a battery mounted on a vehicle is connected to said connection terminals of said battery route to thereby operate said traffic signal.

2. A signal system for operating a traffic signal, comprising:
a signal light;
a control unit for controlling the operation of said signal light; and
a power selecting mechanism for selecting the power to be supplied to said control unit between a commercial power supply and a battery mounted on a vehicle,
wherein said power selecting mechanism includes a battery route having a pair of connection terminals adapted to be connected to said battery of the vehicle, and an electromagnetic switch normally connecting said commercial power supply to said control unit,
when the supply of power from said commercial power supply is cut, said electromagnetic switch automatically performs switching so that said commercial power supply is disconnected from said control unit and said battery route is connected to said control unit, and
said battery of the vehicle is connected to said connection terminals in the event of a power failure, thereby operating said traffic signal.
